(19) United States
(12) Patent Application Publication
(10) Pub. No.: US 2007/0021977 A1
(43) Pub. Date: Jan. 25, 2007

(54) Automated system for capturing and archiving information to verify medical necessity of performing medical procedure

(75) Inventor: John F. Elsholz, Sandy, UT (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: WITT BIOMEDICAL CORPORATION, Melbourne, FL (US)

(21) Appl. No.: 11/273,790

(22) Filed: Nov. 15, 2005

Related U.S. Application Data
(60) Provisional application No. 60/700,434, filed on Jul. 19, 2005.

(51) Int. Cl. G06Q 10/00; G06Q 40/00

(52) U.S. Cl. 705/2; 705/4

(57) ABSTRACT

An automated routine verifies the medical necessity of a procedure. When a procedure is scheduled, the routine searches for, captures and archives patient and clinical information in an audit file, to evidence medical necessity of the procedure. If the audit file lacks one or more pieces of information, medical personnel will be visually alerted to the shortcoming and what is lacking. The user may then activate one or more objects of a user interface, to search resources that contain the required information, so that the audit file may be updated, as necessary, so as to comply with requirements of the Center for Medicare/Medicaid Services.

### CROSS-REFERENCE TO RELATED APPLICATION

The present application claims the benefit of co-pending application Ser. No. 60/700,434, filed Jul. 19, 2005, by John F. Elsholz, entitled: “Mechanism for Verifying and Documenting Necessity of Performing Medical Procedure and User-Based Tool for Selectively Navigating Through Medical Information Database,” assigned to the assignee of the present application and the disclosure of which is incorporated herein.

### FIELD OF THE INVENTION

The present invention relates in general to data storage and retrieval systems and user interfaces therefor, and is particularly directed to an automated system for capturing and archiving patient and clinical information that is effective to verify—comply with guidelines promulgated by the Center for Medicare/Medicaid Services (CMS) for—the medical necessity of performing a given medical procedure, and thereby ensure that the healthcare service provider will be properly reimbursed for the costs of performing the procedure and will be able to readily pass a CMS audit of the medical necessity of procedures performed in its facility by associated medical personnel (physicians).

### BACKGROUND OF THE INVENTION

Recent Medicare audits of medical facilities, such as hospitals, that perform procedures such as cardiac-related procedures, have in many instances not been supplied with adequate documentation evidencing medical necessity for the procedures that comply with CMS guidelines, which has resulted in hospitals and physicians having to refund millions of dollars to HCFA (now CMS). These failed audits have caused executive turnover and the loss of billions of dollars of shareholder value in the largest publicly-held healthcare service networks. Moreover, doctors who bill Medicare for procedures that cannot be proven to be medically necessary face penalties of up to $10,000 per case, an assessment of up to three times the amount billed plus interest, exclusion from federal and state health care programs, and possible criminal prosecution.

One very practical problem with the currently followed auditing routine is the substantial disarray and disconnection of the information required by the auditor to prove medical necessity. In a typical situation, an auditor will go to the medical records department of a healthcare facility and will ask for a prescribed percentage (e.g., 10%, such as 300 out of 3000) of the records associated with a given procedure for the past year, such as a left heart catheterization, as a non-limiting example. These records (charts) are normally retained in a massive library of medical records stored in file cabinet after file cabinet in the medical records department. Hospital records personnel will hunt for files of patients for whom a left heart catheterization was performed, and then proceed to provide the auditor with stacks of charts for his perusal to determine whether they contain documentation sufficient to satisfy CMS's medical necessity standards. In many instances the auditor will find that the files contain either insufficient or no entry of the required information associated with the need for the procedure, even though the need had actually been established by attending medical personnel and pursuant to CMS guidelines before the procedure was performed; namely, there was an inadvertent failure of data entry, rather than a failure of the patient to exhibit all of the symptoms necessary to warrant performing the procedure.

Because of this laxity or neglect on the part of healthcare service providers to realize that risk management is one of the functions they can or should perform, in order to properly document verification of medical necessity and thereby prevent the potential problem of Medicare fraud and abuse, in March of 2005, CMS awarded three year contracts to five independent auditing agencies, known as RACs (Recovery Audit Contractors) to search for Medicare reimbursements of claims that cannot be validated as medically necessary. The auditors are being compensated at a percentage of the amount of overpayments they find, and will initially focus their efforts in three states—California, New York and Florida.

If the efforts of the RACs prove successful in reclaiming large dollar amounts to Medicare, CMS intends to expand these audits across the nation. This will have a predictable outcome—more hospitals will be found to have inadequate documentation that is able to prove to CMS's satisfaction the medical necessity of procedures performed at their institutions. This will expose both doctors and hospitals to large financial penalties, as well as potential criminal charges. It is currently the desire of the Office of the Inspector General, and its Office of Program Integrity, in particular, to find a solution to the above problem and to assist hospitals and doctors in documenting all of their cases properly, so that for any procedure for which Medicare reimbursement is requested, the service provider will be able to provide as complete documentation as possible evidencing medical necessity in the manner required by CMS guidelines.

### SUMMARY OF THE INVENTION

In accordance with the present invention, this objective is successfully addressed by a new and improved automated system for capturing and archiving, in an audit file, patient and clinical information that is required by CMS guidelines and thereby assured to properly evidence the medical necessity of performing a given medical procedure, so as to ensure that the healthcare service provider will be properly reimbursed for the costs of performing the procedure and will be able to readily pass a Medicare audit of its facility and associated medical personnel (physicians). If the compilation of information regarding the patient and the procedure of interest reveals that the audit file lacks one or more pieces of information to satisfy medical necessity requirements, the system will visually alert medical personnel to the extent of the shortcoming and specifically identify what is lacking. This will allow the system user to activate one or more objects of a user interface to initiate a search of available resources that contain the required information, so that the audit file may be completely filled in with whatever information is missing. Once the audit file complies with CMS requirements, the system will alert medical personnel to that fact by a colored (e.g. green) alert indicator for the procedure/patient of interest.

As will be described, the automated software routine of the present invention is readily executed on a workstation of a computer network, such as that installed at a facility of a healthcare provider (e.g., hospital). The network in which the workstation is installed is linked with a number of information systems, in which patient-associated information (such as medical history, demographics, insurance information, indicated physical symptoms, EKG's, echocardiology studies, angiograms, etc.) is captured by hospital personnel, when a patient is admitted to the healthcare facility for medical evaluation and treatment. By having access to these information systems, the verification of medical necessity routine of the invention is readily able to load and update a separate, dedicated ‘audit’ file it maintains on the patient with all currently available information associated with that patient and any procedure performed.

The workstation is linked to diagnostic and test equipment, through which diagnostic and testing information that may indicate the need to schedule a procedure that will confirm the diagnosis (e.g., coronary artery disease) or treat the pathology (e.g. congestive heart failure, Supraventricular tachycardia, etc.). Similarly, once a diagnosis has been completed and a procedure is scheduled, information relating to the procedure, including the type of procedure, physician and attending staff, date of the procedure, the name of the patient on whom the procedure is to be performed, etc. as recorded and stored in the HIS, is stored in the audit file.

For purposes of providing non-limiting, but illustrative examples of the application of the present description to a variety of medical procedures, the description to follow will address the application of the invention to verifying the medical necessity of performing a prescribed set of cardiac-related procedures, in particular, a left heart catheterization, implantable cardiac defibrillator, a pacemaker implant, and a percutaneous coronary intervention. It should be observed, however, that the invention is not limited to the cardiology field, but is applicable to a variety of medical specialties, such as, but not limited to, radiology, orthopedics, oncology, etc.

Associated with each procedure is a sequence of steps that are carried out with respect to the patient by attending medical personnel. These steps include an initial examination of a potentially symptomatic patient, the performing of one or more tests on the patient (which may include the use of medical test equipment) and identifying, collecting and evaluating the evidence of the patient's condition, performing a diagnosis of the patient based upon the evaluation of the evidence, and scheduling a procedure suggested by the diagnosis and that has been determined to be medically necessary according to CMS criteria.

For each procedure there is an associated work flow tree, one or more branches of which list medically necessary criteria for which data entries, specified in accordance with CMS guidelines, must be supplied, to complete the branch and thereby verify the medical necessity of the listed procedure. As long as any branch has complete medical data entered for each of its listed parameters, then all of the requirements for verifying the diagnosis for that branch will have been considered to have been satisfied, and the procedure suggested in accordance with the diagnosis will be considered to be medically legitimate.

As a non-limiting example, in the case of a diagnosis of ventricular fibrillation (V-fib), the following four data entries must be supplied: 1—History and Physical (which are typically presenting symptoms and a listing of physical history obtained during patient assessment, including previous treatments, other medical problems, drug allergies, and more, and are available from the HIS); 2—the results of an EKG performed on the patient; 3—the results of an electrophysiology study performed on the patient; and 4—an emergency department diagnosis showing clinical pathology such as “Long QT Syndrome” that would predispose the patient to a high risk of future cardiac arrests. If all of this information has been obtained, and thereby supports a diagnosis of V-fib, the diagnosing physician knows that he can schedule the implant of a defibrillator.

To determine whether all of the above information has been obtained for verifying the medical necessity of an implantable defibrillator implant on a particular patient of interest, the verification of medical necessity routine of the invention is invoked for the patient of interest, using a graphical user interface, that contains a window that lists the procedure to be performed (implantable defibrillator (ICD)) and the diagnostic indication that supports the need for the displayed procedure (V-fib).

Displayed within the window is an indication of the extent to which the required medical parameter data is present in the audit file. For example, a header “documentation in file?” may be displayed with a yellow background, and identified with the label “partial” to indicate that more information is needed to verify that the listed procedure is medically necessary for the identified patient. Beneath this header is a listing of the four diagnosis-supporting data entries that must be complete, in order to confirm a diagnosis of V-fib, together with a color coded indication and a text indication of the extent to which each data entry is complete.

From an examination of the colors of the entries beneath the procedure and diagnostic listings of the displayed window of the graphical user interface, a medical practitioner can see at a glance whether the performed procedure has been properly verified according to CMS standards as medically necessary. For any patient for which one or more data entries is either partially complete (displayed as yellow), or for which data is currently missing (displayed as red), an array of utilities that are accessible by the verification of medical necessity routine will enable a technician to issue calls to specific modalities, such as EKG machines, emergency department information systems, or laboratory chemistry analyzers, and thereby retrieve the remaining data required, until all listings for that particular patient and procedure are displayed as green. Medical personnel will then know that all criteria for which documentation must be provided as mandated by the CMS to prove medical necessity for the procedure has been obtained, so that it can be expected that not only will CMS provide reimbursement for the procedure, but the record of the patient and procedure as stored in an independent audit file will pass a Medicare audit.

A separate audit file is maintained for every procedure that is performed. This file is a redundant repository of selected information associated with the patient and the procedure, including test results, such as EKGs, lab results, diagnostic angiography images, thallium scans, cardiac CT studies, echocardiograms, etc. The purpose of this audit file is to have all information in one location that is independent of the security and/or status of any other repository. This is the file that is to be accessed during a Medicare audit and, by virtue of the execution of the verification of medical necessity routine of the invention, described above, every patient will be demonstrated to have all required information. This greatly simplifies the auditing process to be able to reveal full documentation from one audit file, for each class of procedure, such as every PCI patient.

In addition to being backed up on a server database and written to a sharepoint designated by the risk management officer in the hospital, the audit files for each physician's procedures are securely forwarded to a sharepoint in the physician's office, so that he/she can always have an auditable verification of any cases for which he/she is accountable.

### BRIEF DESCRIPTION OF THE DRAWINGS

FIG. 1 is a reduced complexity block diagram illustration of a typical computer network, such as may be installed at a facility of a healthcare provider (e.g., hospital), in which the verification of medical necessity routine of the present invention may be employed;

FIGS. 2, 3, 4 and 5 are respective workflow diagrams associated with the application of the present invention to verifying the medical necessity of performing a prescribed set of cardiac-related procedures, in particular, a left heart catheterization, implantable cardioverter defibrillator, a pacemaker implant, and a percutaneous coronary intervention; and

FIG. 6 depicts a graphical user interface employed by the verification of medical necessity routine of the present invention to indicate the completion status of all items required to prove medical necessity of performing an implantable defibrillator based upon an indication of V-fib.

### DETAILED DESCRIPTION

Before describing the automated system of the present invention for capturing and archiving information to verify the medical necessity of performing a medical procedure, it should be observed that the invention resides primarily in a set of data acquiring and storage software, that may be loaded into and executed on a conventional computer (e.g., laptop, desktop, server, and the like), plus associated graphical user interfaces through which the software is controlled, with results of the execution of the software being displayed to a user of the system. As a result, the configuration of the system and the manner in which it may be interfaced with conventional healthcare service provider data storage and processing systems, such as a Hospital Information System (HIS), and equipment employed by the health facility to test and gather symptomatic parameter information on patients have, for the most part, been depicted in the drawings by readily understandable functional block diagrams, and user interface display screens that contain procedure and patient associated menus and medical parameter diagrams, which show only those specific aspects that are pertinent to the methodology of the present invention, so as not to obscure the disclosure with details which will be readily apparent to those skilled in the art having the benefit of the description herein. Thus, the block diagram and associated graphical user interface diagrams are primarily intended to show the major components of a preferred embodiment of the invention in convenient functional groupings, whereby the present invention may be more readily understood.

Moreover, as noted above, it is to be understood that the methodology of the present invention is readily able to verify the medical necessity of performing a wide variety of medical procedures, and thus is not intended to be limited in its scope. For purposes of providing a non-limiting, but illustrative, example of its use, the following description will address the application of the invention to verifying the medical necessity of performing a number of cardiac-related procedures, such as a diagnostic angiogram, a pacemaker implant, a left heart catheterization, and an implantable cardioverter defibrillator.

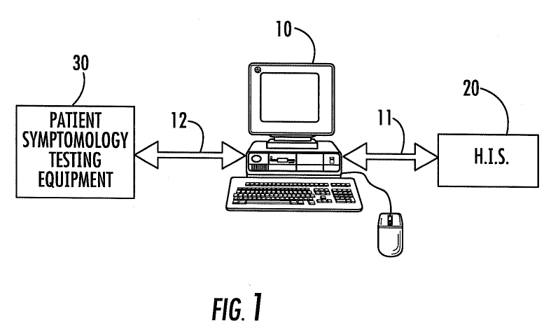

Attention is initially directed to FIG. 1, which is a reduced complexity block diagram illustration of a typical computer network, such as may be installed at a facility of a healthcare provider (e.g., hospital), in which the present invention may be employed. As shown therein, the service provider network includes a desktop computer or workstation 10, in which the verification of medical necessity software of the present invention has been installed, and through which healthcare personnel are able to navigate among respective displayed windows of a graphical user interface for the purpose of identifying procedures performed and patients on whom they were performed, as well as clinical procedure criteria that must be satisfied, in order to comply with verification of medical necessity requirements set forth in CMS guidelines.

As pointed out briefly above, the network in which the workstation is installed includes a link 11 between the workstation 10 and a Hospital Information System (HIS) 20 and/or other information systems, in which patient-associated information (such as medical history, demographics, insurance information, indicated physical symptoms (such as crushing chest pain, dizziness, fainting, chest palpitations), EKG's, echocardiology studies, angiograms, etc.) is initially captured by hospital personnel, when a patient is admitted to the healthcare facility and during medical evaluation and treatment. By having access to these information systems, the verification of medical necessity routine of the present invention is readily able to load and update a separate, dedicated ‘audit’ file it maintains on the patient with all currently available information associated with that patient and any procedure performed. However, it is essential to note that connectivity to the HIS is not required for the present invention to function. All of the information that is obtained from the HIS can be manually entered into the software application when it operates in a stand-alone mode.

The network also includes a link 12 to diagnostic and test equipment, through which diagnostic and testing information that may indicate the need to perform a procedure (e.g., cardiac catheterization) that will confirm the diagnosis (e.g., coronary artery disease) or treat the pathology (e.g., congestive heart failure, supraventricular tachycardia, etc.) may be obtained. Similarly, once a diagnosis has been completed and a procedure is scheduled, information relating to the procedure, including the type of procedure, physician and attending staff, date of the procedure, the name of the patient on whom the procedure is to be performed, etc. as recorded and stored in the HIS, is stored in the audit file.

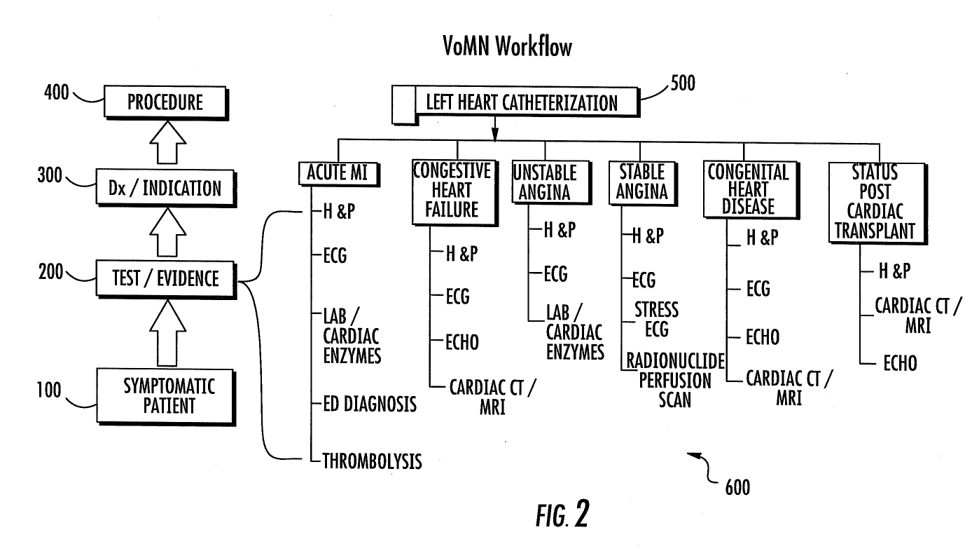

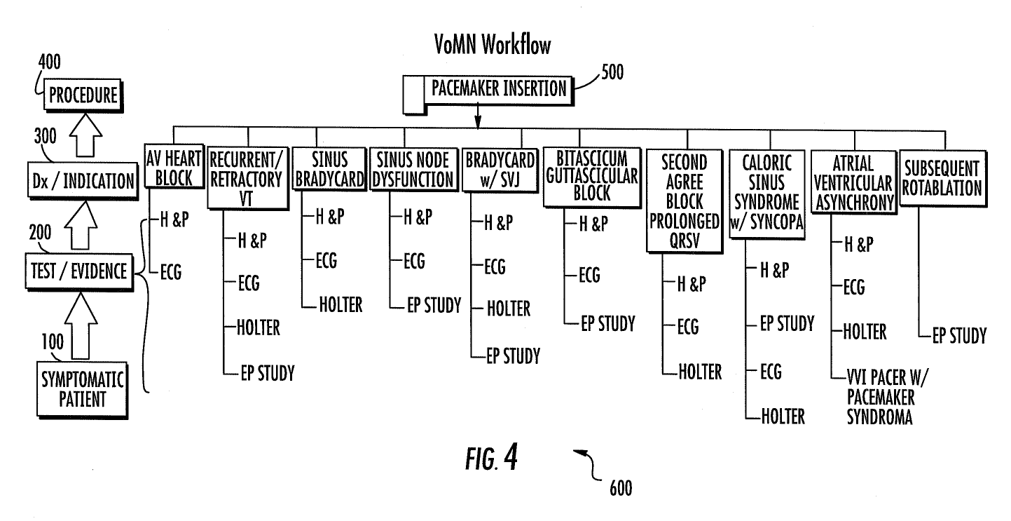

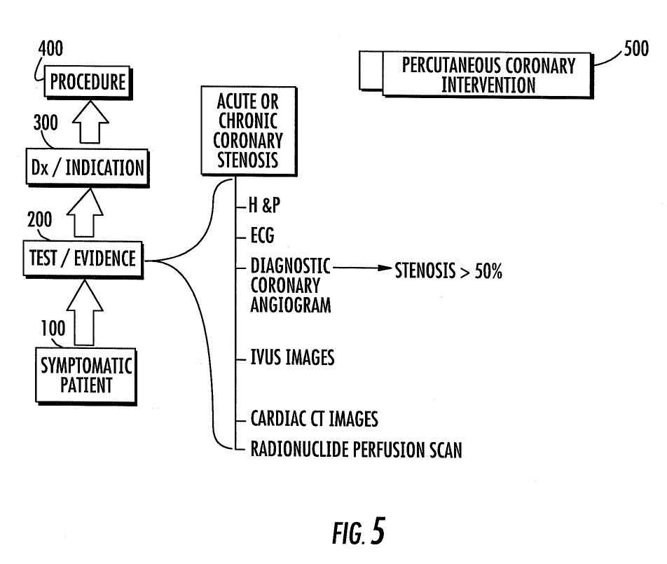

As pointed out above, for purposes of providing non-limiting, but illustrative examples of the application of the present description to a variety of medical procedures, the present description will address the application of the invention to verifying the medical necessity of performing a prescribed set of cardiac-related procedures, in particular, a left heart catheterization, implantable cardiac defibrillator, a pacemaker implant, and a percutaneous coronary intervention (diagnostic angiogram), workflow diagrams for which are shown in FIGS. 2 through 5, respectively.

At the left hand side of each of these Figures is a sequence of steps 100-400, that are carried out with respect to the patient by attending medical personnel. These steps begin with the initial examination of a potentially symptomatic patient 100, the performing of one or more tests 200 on the patient (which may include the use of medical test equipment) and identifying, collecting and evaluating the evidence of the patient's condition, performing a diagnosis 300 of the patient based upon the evaluation of the evidence, and scheduling and performing a procedure 400 that has been determined to be medically necessary according to CMS standards.

The right hand side of each of FIGS. 2 through 5 contains a header 500, which identifies a specific cardiac-related procedure to be performed at step 400 in the sequence flow 100-400. From each header extend one or more branches of a medically necessary criteria tree 600, with each branch listing a number of medical parameters for which data entries, specified in accordance with CMS guidelines, must be supplied, to complete the branch and thereby verify the medical necessity of the listed procedure. As long as any branch has the appropriate medical data entered for each of its listed parameters, then all of the requirements for verifying the diagnosis at the top of that branch will have been considered to have been satisfied, and the resulting diagnosis will be considered to be a legitimate medical necessity for performing the procedure.

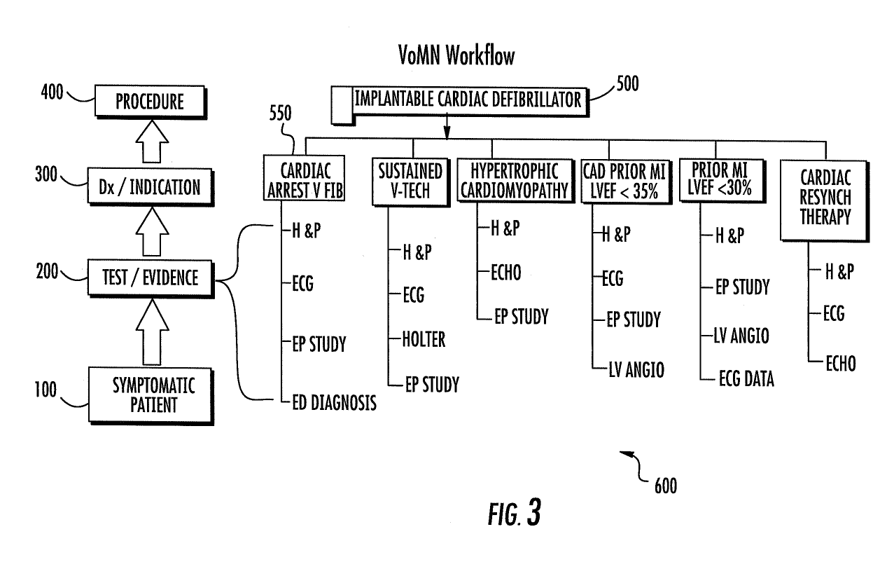

Thus, as a non-limiting example, consider the diagnosis of ventricular fibrillation (V-fib) 550 at the left hand portion of the medically necessary criteria tree 600 in FIG. 3, which lists various requirements that will satisfy the medical necessity for an implant of a cardiac defibrillator. To support a diagnosis of cardiac arrest due to V-fib, the following four data entries must be supplied: 1—History and Physical (which are typically presenting symptoms and a listing of physical history obtained during patient assessment, including previous treatments, other medical problems, drug allergies, etc. and are available from the HIS); 2—the results of an EKG performed on the patient; 3—the results of an electrophysiology study performed on the patient; and 4—an emergency department diagnosis showing clinical pathology, such as a “Long QT Syndrome” that would predispose the patient to a high risk of future cardiac arrests. If all of this information has been supplied to the verification of medical necessity routine, and thereby supports a diagnosis of V-fib, the diagnosing physician knows that he can schedule the implant of a defibrillator at step 400.

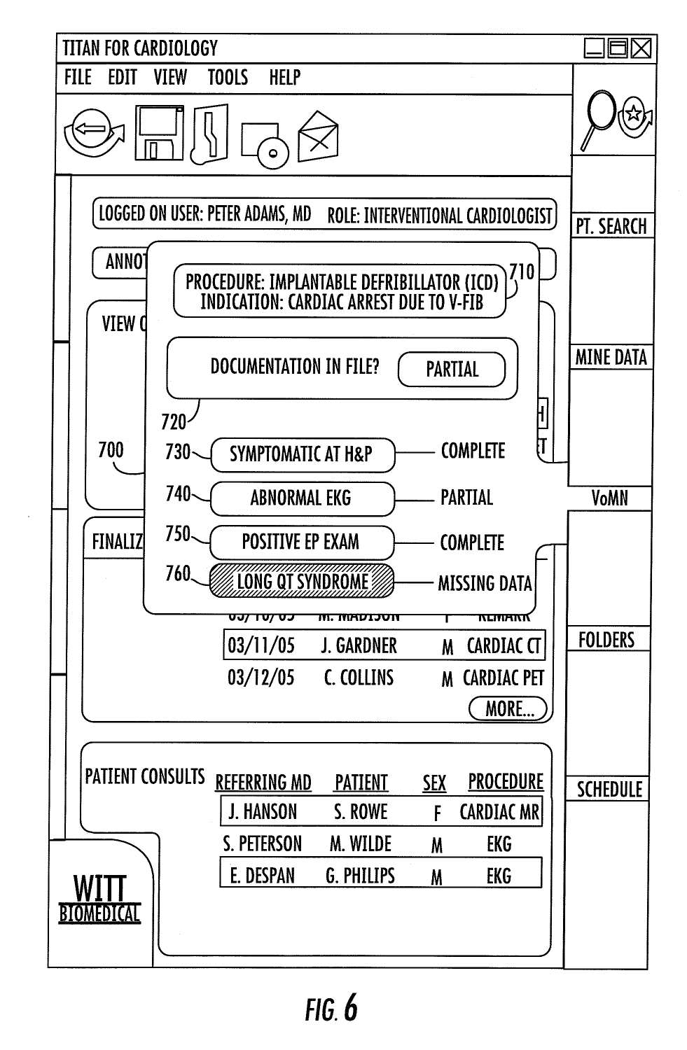

To determine whether all of the above information has been obtained for verifying the medical necessity of an implantable defibrillator implant on a particular patient of interest, the verification of medical necessity routine of the invention is invoked for the patient of interest, using a graphical user interface of the type depicted in FIG. 6. As shown therein, invoking this routine (VOMN) will indicate whether, for the indicated diagnosis, here, V-fib, all of the information required to support the diagnosis and procedure has been acquired. In the graphical user interface shown in FIG. 6, a window 700 is generated, a subwindow 710 of which lists the procedure to be performed (implantable defibrillator (ICD)) and the diagnostic indication that supports the need for the displayed procedure (cardiac arrest due to V-fib).

In accordance with the verification of medical necessity routine of the invention, an indication of the extent to which the required medical parameter data is present in the audit file is displayed in a subwindow 720. In the illustrated example, the header “documentation in file?” is displayed with a yellow background, and identified with the label “partial” to indicate that more information is needed to verify that the listed procedure is medically necessary for the identified patient. Beneath this header is a listing of four data entries 730, 740, 750, 760 that must be complete, in order to support a diagnosis of V-fib, together with a color coded indication and a text indication of the extent to which each data entry is complete. The first data entry 730 “symptomatic at H&P” (from the first branch of the tree of FIG. 3) is colored green and is additionally labelled as “complete”. The second data entry 740 (again from the first branch of the tree of FIG. 3) identifies the EKG as “abnormal” and is colored yellow—indicating that more complete information on the EKG needs to be accessed, so that it is labelled as “partial”. The third data entry 750 (also shown in the first branch of FIG. 3) identifies the EP exam as “positive” and is colored green, indicating the parameter information is complete. Finally, the fourth listed data entry 760 (the last listing in the first branch of FIG. 3) “Long QT Syndrome” is colored red, indicating a lack of data, and is therefore listed as “missing.”

From an examination of the colors of the entries beneath the procedure and diagnostic listings of the displayed window of the graphical user interface of FIG. 6, a medical practitioner can readily determine at a glance whether the performed procedure has been properly verified according to CMS standards as medically necessary. For any patient for which one or more data entries is either partially complete (displayed as yellow), or for which data is currently missing (displayed as red), an array of utilities that are accessible by the verification of medical necessity routine will enable a technician to issue calls to specific modalities, such as EKG machines, emergency department information systems, or laboratory chemistry analyzers, and thereby retrieve the remaining data required, until all listings for that particular patient and procedure are displayed as green. Medical personnel will then know that all criteria for which documentation must be provided as mandated by the CMS to prove medical necessity for the procedure has been obtained, so that it can be expected that not only will CMS provide reimbursement for the procedure, but the stored record of the patient and procedure as stored in an independent audit file will pass a Medicare audit.

To this end, as a further feature of the invention, in addition to a pre-procedure checklist of the type described above, and shown in FIGS. 2-6, a separate audit file is maintained for every procedure that is performed. This file is a redundant repository of selected information associated with the patient and the procedure, including test results, such as EKGs, lab results, diagnostic angiography images, thallium scans, cardiac CT studies, echocardiograms, etc. The purpose of this audit file is to have all information in one location that is independent of the security and/or status of any other repository. This is the file that is to be accessed during a Medicare audit and, by virtue of the execution of the verification of medical necessity routine of the invention, described above, every patient will be demonstrated to have all required information. This greatly simplifies the auditing process to be able to reveal full documentation from one audit file, for each class of procedure, such as every PCI patient.

In addition to being backed up on a server database and written to a sharepoint designated by the risk management officer in the hospital, the audit files for each physician's procedures are securely forwarded to a sharepoint in the physician's office, so that he/she can have an auditable verification of any cases for which he/she is accountable.

As will be appreciated from the foregoing description, pursuant to the present invention, the aforementioned desire of the healthcare service community, including the Center for Medicare/Medicaid Services (CMS), as well as medical service facilities and physicians, that any performed procedure for which reimbursement is requested from CMS be documented to the extent necessary to verify that the procedure was medical necessary, as specified by CMS guidelines, is readily accomplished by a verification of medical necessity software routine that is effective to capture and archive, in an audit file, patient and clinical information that is required by CMS guidelines, and thereby assured to properly evidence the medical necessity of a performing a given medical procedure, so as to ensure that the healthcare service provider will be properly reimbursed for the costs of performing the procedure and will be able to readily pass a Medicare audit of its facility and associated medical personnel (physicians). If the compilation of information regarding the patient and the procedure reveals that the audit file lacks one or more pieces of information necessary to meet medical necessity requirements, the system will visually alert medical personnel to the extent of the shortcoming and specifically identify what is lacking. This will allow the system user to activate one or more objects of a user interface to initiate a search of available resources that contain the required information, so that the audit file may be updated with whatever information is missing. Once the audit file complies with CMS requirements, the system will alert medical personnel to that fact by a colored (e.g. green) alert indicator for the procedure/patient.

While I have shown and described an embodiment in accordance with the present invention, it is to be understood that the same is not limited thereto but is susceptible to numerous changes and modifications as known to a person skilled in the art, and I therefore do not wish to be limited to the details shown and described herein, but intend to cover all such changes and modifications as are obvious to one of ordinary skill in the art.

What is claimed:

1. For use with a medical information collection and processing system of a medical facility, where a medical procedure may be performed upon a patient of said facility, an application software routine that is executable on said system and is operative to verify the medical necessity of performing said procedure upon said patient, said routine comprising the steps of:
(a) in response to initiating said routine, proceeding to search for and acquire information that has been collected with respect to said patient, including patient history and physiological parameters of said patient required by criteria that must be satisfied to verify the need for performing said procedure;
(b) providing visual indications, on a graphical user interface of said system, of the extent to which information collected on said patient comply with said criteria;
(c) in response to one or more visual indications on said graphical user interface indicating that one or more of said criteria has not been satisfied, communicating with information sources from which information of said patient necessary to satisfy said one or more criteria may be obtained, and acquiring therefrom said necessary information; and
(d) storing, in an auditable archival file, all information that has been collected with respect to said patient and said procedure, required by criteria that must be satisfied to verify the need for performing said procedure.

2. The application software routine according to claim 1, wherein said criteria that must be satisfied to verify the medical necessity for performing said procedure are criteria prescribed by the Center for Medicare/Medicaid Services.

3. The application software routine according to claim 1, wherein step (b) comprises, in association with a respective one of said criteria,
(b1) providing a first color indication on said graphical user interface of said system, if collected information of said patient is sufficient to satisfy said respective one of said criteria;
(b2) providing a second color indication on said graphical user interface of said system, if collected information of said patient is sufficient to only partially satisfy said respective one of said criteria; and
(b3) providing a third color indication on said graphical user interface of said system, if no information of said patient, that will satisfy said respective one of said criteria, has been collected.

4. The application software routine according to claim 3, wherein said first color is green, said second color is yellow and said third color is red.

5. The application software routine according to claim 1, wherein said medical procedure may comprise a cardiology, radiology, or other medically related procedure.

6. The application software routine according to claim 1, wherein said medical procedure is a cardiology related procedure comprising one of a left heart catheterization, an implantable cardiac defibrillator, a pacemaker implant, and a percutaneous coronary intervention (diagnostic angiogram).

7. The application software routine according to claim 1, wherein information of said patient required by said criteria include results of clinical testing of said patient.

8. The application software routine according to claim 1, wherein criteria that must be satisfied to verify the need for performing said procedure are those associated with a prescribed diagnosis for which said procedure is an appropriate treatment.

9. The application software routine according to claim 1, wherein said routine is operative, in response to invoking a field on said graphical user interface containing the name of said patient, to cause said graphical user interface to display a list of criteria required to verify the medical necessity of said procedure for said patient, and the extent to which each of said criteria has been satisfied in accordance with information collected on said patient.

10. The application software routine according to claim 9, wherein said routine is operative to cause said graphical user interface to display indications of the extent to which each of said criteria has been satisfied, in accordance with information collected on said patient, in the form of color-coded information fields.

11. For use with a medical information collection and processing system of a medical facility, where a medical procedure may be performed upon a patient of said facility, an application software routine that is executable on said system and is operative to verify the medical necessity of performing said procedure upon said patient, said routine comprising the steps of:
(a) in response to scheduling said medical procedure for said patient, proceeding to search for and acquire information collected with respect to said patient that is necessary to satisfy criteria for verifying the medical necessity of performing said procedure, as promulgated by the Center for Medicare/Medicaid Services;
(b) providing visual indications, on a graphical user interface of said system, of the extent to which information collected on said patient satisfy said criteria;
(c) in response to one or more visual indications on said graphical user interface indicating that one or more of said criteria has not been satisfied by said collected information, communicating with information sources from which information of said patient necessary to satisfy said one or more criteria may be obtained, and acquiring therefrom said necessary information; and
(d) storing, in an auditable archival file, all information that has been collected with respect to said patient and said procedure, required by said criteria that must be satisfied to verify the need for performing said procedure.

12. The application software routine according to claim 11, wherein step (b) comprises, in association with a respective one of said criteria,
(b1) providing a first color indication on said graphical user interface of said system, if collected information of said patient is sufficient to satisfy said respective one of said criteria;
(b2) providing a second color indication on said graphical user interface of said system, if collected information of said patient is sufficient to only partially satisfy said respective one of said criteria; and
(b3) providing a third color indication on said graphical user interface of said system, if no information of said patient, that will satisfy said respective one of said criteria, has been collected.

13. The application software routine according to claim 12, wherein said first color is green, said second color is yellow and said third color is red.

14. The application software routine according to claim 11, wherein said medical procedure comprises one of a cardiology, radiology, orthopedics, oncology or other medically related procedure.

15. The application software routine according to claim 11, wherein said medical procedure is a cardiology related procedure comprising one of a left heart catheterization, an implantable cardiac defibrillator, a pacemaker implant, and a percutaneous coronary intervention (diagnostic angiogram).

16. The application software routine according to claim 11, wherein information of said patient required by said criteria include results of clinical testing of said patient.

17. The application software routine according to claim 11, wherein criteria that must be satisfied to verify the need for performing said procedure are those associated with a prescribed diagnosis for which said procedure is an appropriate treatment.

18. The application software routine according to claim 11, wherein said routine is operative, in response to invoking a field on said graphical user interface containing the name of said patient, to cause said graphical user interface to display a list of criteria required to verify the medical necessity of said procedure for said patient, and the extent to which each of said criteria has been satisfied in accordance with information collected on said patient.

19. The application software routine according to claim 18, wherein said routine is operative to cause said graphical user interface to display indications of the extent to which each of said criteria has been satisfied, in accordance with information collected on said patient, in the form of color-coded information fields.
